(19) United States
(12) Patent Application Publication
(10) Pub. No.: US 2012/0013738 A1
(43) Pub. Date: Jan. 19, 2012

(54) VIDEO SURVEILLANCE SYSTEM AND METHOD WITH DISPLAY ADVERTISING

(75) Inventors: Fabio Teti, Waxhaw, NC (US); Jeffrey Necciai, Matthews, NC (US)

(73) Assignee: SDR SOLUTIONS, LLC, Charlotte, NC (US)

(21) Appl. No.: 13/184,130

(22) Filed: Jul. 15, 2011

Related U.S. Application Data
(60) Provisional application No. 61/364,654, filed on Jul. 15, 2010.

(51) Int. Cl. H04N 7/18

(52) U.S. Cl. 348/143; 348/E07.085

(57) ABSTRACT

A system for communicating content and monitoring a specified area, and method providing the same, includes a communications module including communication devices. The communication devices may include a display, a camera, and a microphone. The communications module also includes a first computer. A remote operations module includes an operations computer. The remote operations module communicates with the communications module using the operations computer. The operations computer communicates with the communication devices of the communications module and is configured to control the communications module. A plurality of operation modes may include: a first mode including the display being configured to display specified uploaded or streaming multimedia content, while providing a remote operator with real time video from a video camera for surveillance monitoring; and a second mode including the display being configured to display a remote operator of the remote operations module in two way communication with the communications module.

### CROSS-REFERENCE TO RELATED APPLICATION

This application claims priority under 35 U.S.C. §119(e) of U.S. Provisional Patent Application Ser. No. 61/364,654 filed Jul. 15, 2010, the disclosure of which is hereby incorporated by reference in its entirety.

### FIELD OF THE INVENTION

The present invention generally relates to monitoring and surveillance systems, combined with content communicating devices, such as marketing and advertising devices and methods related thereto.

### BACKGROUND OF THE INVENTION

In the field of security systems and surveillance systems, many systems provide video security which may be stored on a tape, film or other storage device, or may be remotely monitored by an operator. One problem with current security systems is that there is no way for a remote operator to communicate at the area under surveillance. For example, when the operator views an event wherein a quick intervention is needed, the operator must alert personnel in the area, or local law enforcement, which requires time for communication to be initiated and implemented. In an emergency situation, such time delays can be critical. Further, existing security and surveillance systems are readily detected by a person, which may avoid or disable the point of surveillance if they are planning an unlawful enterprise.

Therefore, a need exists for a security device with surveillance functions which is capable of several modes of operation, including communicating information and data to persons in the area of surveillance, and the ability to expedite intervention in the area under surveillance, e.g., open communication with persons in the area under surveillance. Further, it would be desirable for a security device to allow for remote monitoring and management. Also, a need exists for a security and surveillance system which is covert in nature, and therefore is not easily detected by persons planning or conducting an unlawful activity. Additionally, it would be desirable for security/surveillance system to be capable of including other functionalities related to revenue generation, such as advertising and marketing.

### SUMMARY OF THE INVENTION

In an aspect of the invention, a system for communicating content and monitoring a specified area includes a communications module including communication devices. The communication devices include a display, a camera, and a microphone, and the communications module further includes a digital input and output port. The communications module also includes a first computer including a processor unit and associated memory storage device I/O etc. A remote operations module includes an operations computer. The remote operations module communicates with the communication module using the operations computer. The operations computer communicates with the communication devices of the communications module and is configured to control the communications module for remote surveillance operation and audio/video display operation.

In a related aspect, a plurality of operation modes include: a first mode including the display being configured to display specified content while enabling real-time remote video and audio surveillance to be conducted by a remote operator of the remote operations module; and a second mode, including the display being configured to display a remote operator of the remote operations module in two way engagement with the communications module, and the plurality of operation modes are initiated from the remote operations module.

In another aspect of the invention, a method for communicating content and monitoring a specified area comprises: monitoring a specified area, comprising: communicating, from a remote operations module, control signals for configuring an integrated display which includes a video camera and a microphone, and a first computer; receiving, at the integrated display, the control signals and configuring the integrated display for a first operation mode including covert surveillance of the specified area; communicating to a remote operator of the remote operations module, real time signals from the video camera of the specified area for surveillance monitoring in a first operation mode, wherein the remote operations module includes an operations computer; and providing a remote operator of the remote operations module with real-time video from the video camera for surveillance monitoring in the first operation mode, wherein the display is configured to display specified content.

In a related aspect of the invention, selectively initiating a plurality of operation modes using the remote operations module may include: configuring the display to display a specified content while enabling real-time remote video and audio surveillance conducted by the remote operator of the remote operations module in a first mode; and providing selective initiation for the display to display a remote operator of the remote operations module in two way engagement with the communications module in a second operation mode, and the plurality of operation modes are initiated from the remote operations module.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is schematic block diagram of a system for communicating content and monitoring a specified area according to an embodiment of the invention;

FIG. 2 is a schematic block diagram of the system shown in FIG. 1 having a integrated display;

FIG. 3 is schematic block diagram of connections for the system shown in FIG. 1;

FIG. 4 is a schematic block diagram of an embodiment of a screen configuration for a remote operator;

FIG. 5 is a flow chart of a method according to an embodiment of the invention related to the integrated display of FIG. 2 interaction with a remote operations module of FIG. 1;

FIG. 6 is a flow chart of a method according to an embodiment of the invention related to the integrated display of FIG. 2 interaction with a remote operations module of FIG. 1;

FIG. 7 a perspective view according to an embodiment of the invention showing the components shown in FIG. 2; and

FIG. 8 is a perspective view according to an embodiment of the invention depicting a display of the remote operator's computer shown in FIG. 1

### DETAILED DESCRIPTION OF THE INVENTION

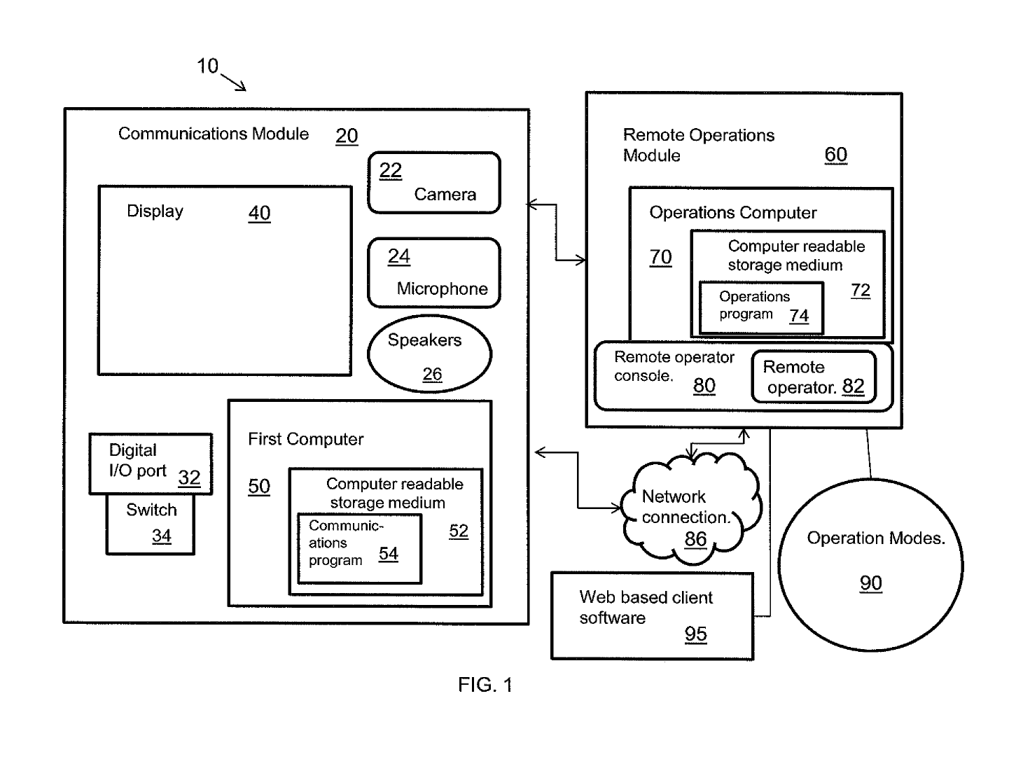

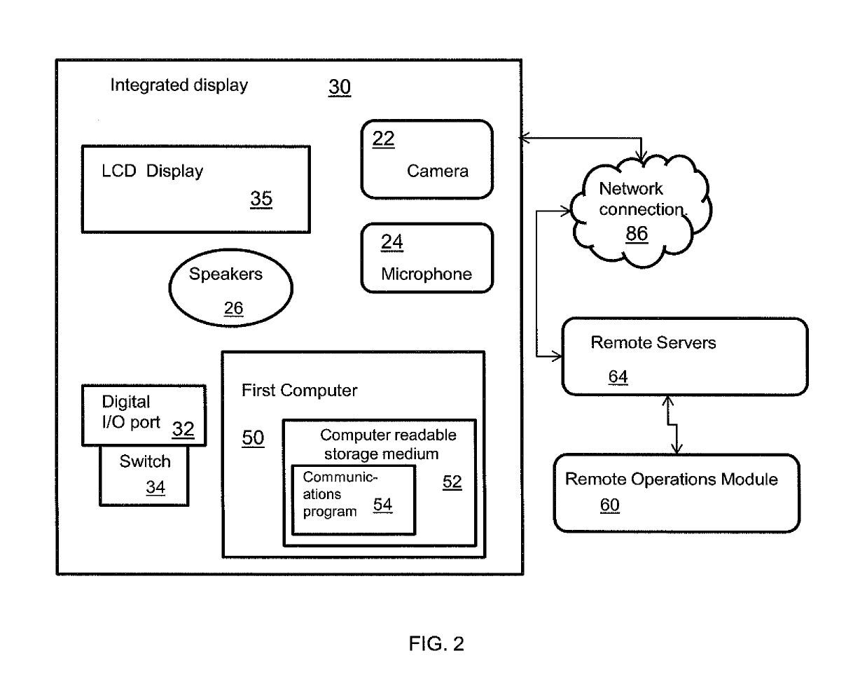

Referring to FIG. 1, a system 10 for communicating content and monitoring a specified area according to an embodiment of the invention includes a communications module 20. The content may include audio and visual content, such as pictures, movies, music, and messages. In one embodiment, the content include marketing and advertisement content. The communications module 20 includes communication devices, such as a display 40, a camera 22, and a microphone 24, each operable under control of a first computer 50. The camera 22 includes a video camera capable of streaming live (real-time) video to a remote receiver. The display 40 may be an LCD (liquid crystal display) or LCD panel suitable for display in a specified area for a plurality of viewers. The communications module further includes a digital input and output port 32. The communications module also includes a first computer 50 including a computer readable storage medium 52 which embodies a computer program 54 which also may be referred to as a communications program. The communications module 20 may include, in several embodiments, multiple cameras and microphones, as well as other audio visual equipment, and monitoring devices. The elements of the communications module 20 may be one or more separate elements electrically connected as necessary, or in an alternative embodiment, the display may incorporate all the elements and functionality of the communications module 20, and is thereby referred to as an integrated display 30, as shown in FIG. 2. The integrated display 30 also includes the same components and connections as the communications module. However, the integrated display 30 includes the LCD or LCD panel 35 as part of the singular display unit which includes embedded elements as shown in FIG. 2. Also, in the embodiment shown in FIG. 2, the integrated display 30 communicates with the remote operations module 60 using remote servers 64 via a network 86, which may include the Internet.

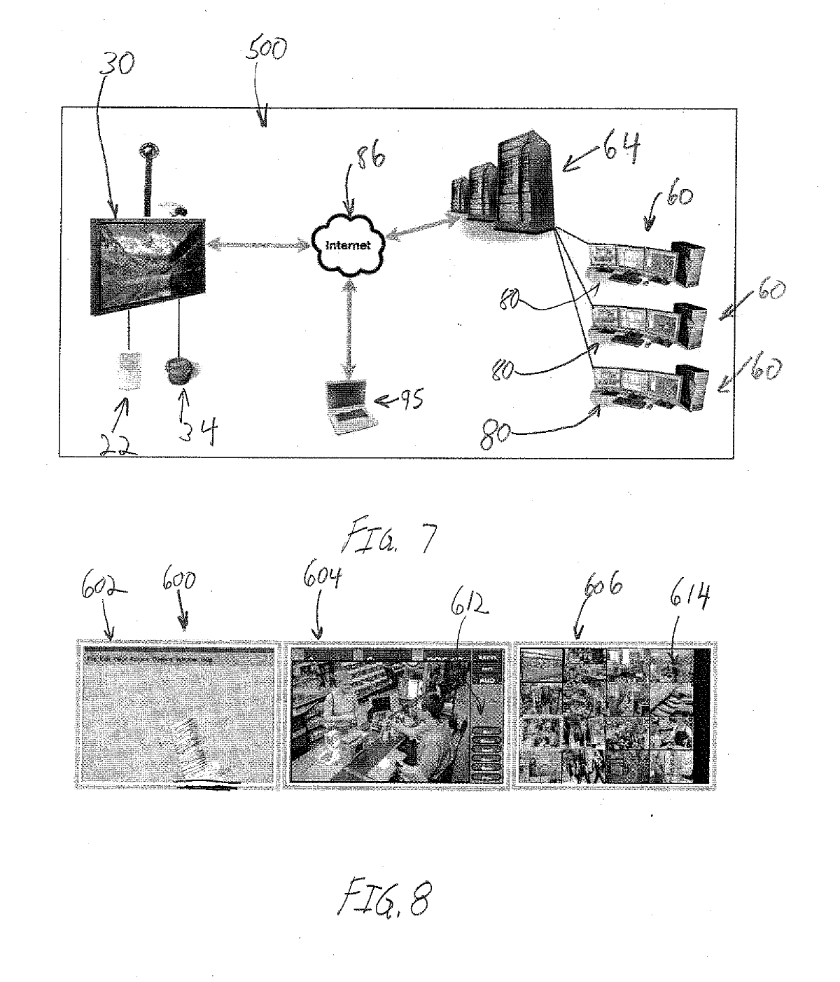

Referring to FIG. 7, an embodiment of the system 500 is shown which includes like numerals for the same components shown in FIGS. 1 and 2. The system 500 depicts the integrated display 30 with the camera 22 and switch 34 (or trigger). The integrated display 30 is connected to the internet 86 which connects the integrated display 30 to the web based client software 95 shown on a computer (e.g., a laptop), and the remote servers 64. The remote servers are connected to the remote operations modules 60 each having remote operator consoles 80.

The system 10 further includes a remote operations module 60 including an operations computer 70 which includes computer readable storage medium 72 embodying a computer program 74 (also referred to as an operations program). The remote operations module 60 communicates with the communications module 20 using the operations computer 70. The operations computer 70 communicates with the communication devices of the communications module 20, and is configured to control the devices of the communications module 20.

The system 10 also includes a plurality of operation modes 90. The operation modes include: a first mode including the integrated display 30 being configured to display specified content while enabling real-time remote video and audio surveillance to be conducted by a remote operator of the remote operations module; and a second mode including the integrated display being configured to display, and send and receive audio, of the remote operator at the remote operations module in a two-way engagement.

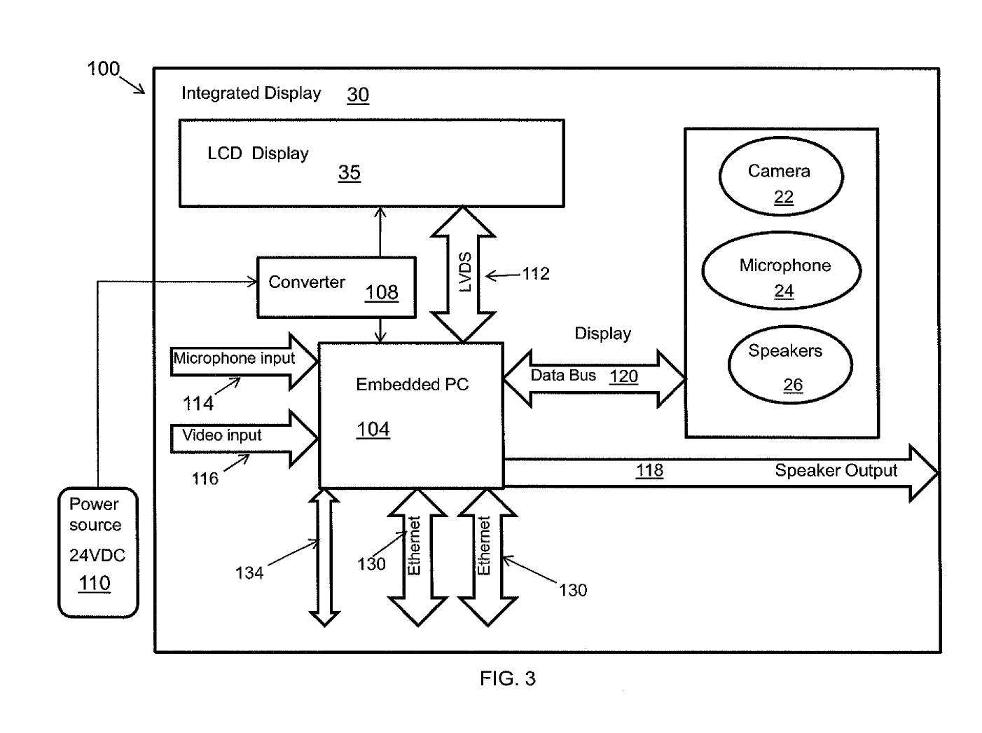

Referring to FIG. 3, according to an embodiment of the invention, hardware attributes of the integrated display 30 (shown in FIG. 2) include the LCD panel display 35 connected to the first computer which is embodied as an embedded computer or PC 104. The embedded computer in connected to the LCD 35 using an LVDS connection 112 (low-voltage differential signaling). A converter 108 connected to a power source 110 can convert 24 VDC power from the power source to 12 VDC for use by the LCD 35 and the embedded computer 104. In the remote surveillance mode of operation, embedded computer 104 receives audio signal input from the microphone and real-time video surveillance content via inputs 114, 116 from the microphone 24 and video camera 22, respectively.

The embedded computer 104 can also receive and send data along the real-time audio and video surveillance content to the remote operations computer and remote operator via Ethernet 130 or like network communications. A data bus 120, for example, is provided for conducting control signals from the PC 104 for controlling the camera 22, and microphone 24. Audio signal content is further provided to the speakers 26 via a speaker output lines 118. Ethernet connections 130 provide internet access for the embedded computer 104, and one or more GPIO's (general purpose input/outputs) 134 are also connected to the embedded computer 104.

In the embodiment of the invention described above, the integrated display 30 may be a multifunctional display allowing the system 10 to be used as both a security tool capable of surveillance, and a marketing tool, for example, displaying advertising. Other examples of content for display of the multifunctional display include: specified data or information, such as weather, news or traffic, advertisements, or instructions, such as emergency instructions; pictures or video, such as scenery.

Additionally, in view of FIG. 1 the system 10 may be used as a security/surveillance tool, which allows a remote operator 82 to conduct video and audio surveillance in either a covert or open manner using a remote operator console 80. When the operator 82 is accessing the integrated display 30 covertly, the casual observer is given no indication that they are being monitored, while the remote operator can see and hear activity in a specified area, which may be defined as the area accessible to the camera 22 and microphone 24. In the mode above, the integrated display 30 displays the marketing/advertising material while the remote operator via remote operations computer performs surveillance operations. That is, monitored audio and video signals from first computer are communicated to the remote operator for monitoring the area while the display provides display content at the area. Should the remote operator choose to engage the integrated display, the display of marketing/advertising material is interrupted and a two-way video/audio session is established allowing real-time interaction between the remote operator and the casual observer.

Further, when the integrated display 30 functions as a marketing display (or advertising player), the integrated display is capable of playing various types of multimedia, including: movies, music, digital photos, and other types of multimedia files such as MP4, MP3, AVI, JPEG, etc. The collection of media may be managed and organized remotely via a network connection 86. For example, the system 10 may be used by customer-facing retail establishments such as retail stores and restaurants. However, the dual nature of the system 10 can be beneficial to other types of industries as well, including: supermarket/drugstore; office buildings; restaurants; schools; and hospitals.

The system 10 described above, is comprised of two separate parts, the communications module 20, including the display 40, and the remote operations module 60, including the remote operator console 80. The remote operator console 80 includes a program 74 or software application. In alternative embodiments of the invention, the remote operator console can be used to monitor and control multiple displays. Both parts of the system 10, the communications module 20 and the remote operations module 60, communicate with each other over the network connection 86, for example, the Internet.

Further, the remote operator console my include multiple displays. In one example, three displays may be used wherein the three screens are for specific purposes. In this example, the operator's attention may be concentrated on a center screen displaying a task screen.

In one embodiment of the invention, the communication module elements, such as the camera and microphone and computer system are integrated into the display. The display 40 may include an LCD (or Plasma) display panel which may be connected to, or have integral, an on-board computer 50 to control the various functions. In addition, the display 40 may be connected to, or have integral, the camera 22, microphone 24, and one or more digital I/O ports 32.

While the camera 22 and microphone 24 are used to capture audio and video, the digital I/O port 32 is used to capture an external trigger signal or switch 34, such as a panic button or intrusion alarm. The computer 50 used in the display may be a low-profile (e.g., single-board) computer utilizing an embedded operating system.

The program 74 may be referred to as a remote operator console application, and may be configured to run on a computer to initiate the various operating modes. Further, the program 74 may be designed to run under the Microsoft Windows® Operating System. However, other operating systems such as MAC™ OS X™ and Linux™, may be used as operating systems. The program 74 may facilitate the access and management of one or multiple displays 40 or multiple communications modules 20. Using the program 74 or remote operator console application, the remote operator 80 may, for example, perform the following functions or tasks: remotely monitor the real-time audio and video content received from a single display; establish a two-way audio/video session with a single display; record the real-time audio/video content from the single display; monitor for activation of a trigger from multiple displays; manage the marketing/advertising content to be displayed by the one or more displays; and/or run diagnostics on a single display.

The system 10 may operate in various operation modes 90, which may depend on what the remote operator wants to achieve. Various examples of selectable operation modes 90 are discussed below.

In a covert mode, covert monitoring can be achieved by the remote operator. In the covert mode, the remote operator can receive real-time audio and video content from the embedded video camera 22 at the integrated display while the display is simultaneously displaying other A/V content. The real-time monitoring is performed without affecting what is being displayed on the unit. There is no indication for the casual observer that they are being monitored. For example, advertising and marketing multimedia continue to be played as normal during covert monitoring.

In operation, when the remote operator wishes to covertly monitor a display, the operations program 74 sends a special message via Ethernet connections to the specific integrated display 30. In response to the special message, the integrated display sets up (i.e., publishes) a multimedia stream that can be accessed by the remote operator console application or operations program 74. The operations program 74 via computer device, receives over the network, the multimedia stream and plays it (or displays it) within the console for the remote operator 82 to view. While in the covert monitoring mode, the remote operator has the following functions available: record the audio and video (to a local file or to central storage); establish a two-way audio/video session (called “engagement”); save snapshots (for example, individual photos, such as JPEG files of single frames of video); and disconnect from the display.

In a two-way Audio/Video Engagement mode, the remote operator establishes a two-way audio and/or video session with an integrated display 30, this is called an “engagement”. Once engaged, the remote operator becomes visible on the display. In addition, the remote operator can make announcements that will be carried over the speakers of the integrated display. While engaged, the integrated display 30 suspends the playing of the audio and/or video marketing/advertising media content. This audio and video contents is replaced by live video and audio originating from the remote operator 82. During an engagement, the remote operator has the following functions available: record the audio and video (to a local file or central storage), wherein the operator has the ability to record the audio and video from the integrated display as well as the audio and video that the remote operator is broadcasting; end the engagement and return to covert monitoring; save snapshots (i.e., individual photos JPEG files of single frames of video); and disconnect from the integrated display.

In an alert mode or a trigger monitoring mode, the remote operations module is configured to receive real-time audio and video communication from the communications module, and the remote operations module is configured to receive an alert signal. A trigger (or switch) on the integrated display 30 initiates generation of an alert signal from communication from the communications module for initiating the alert signal of the alert mode. When the alert signal is received via network connection at the remote module, the remote operator then establishes a two-way audio/video session with the integrated display (“engagement”). Once engaged, the remote operator becomes visible on the display, and the remote operator can make announcements that will be carried over the speakers of the integrated display, as described above.

Furthermore, the remote operator console application is designed and configured to “listen” for external triggers from one or more communications modules or integrated displays. The external triggers originate from various devices connected to the input/output port 32. One example of such a device is a panic button such as shown in FIG. 7. When activated, the panic button will cause a trigger message to be sent through the network connection to the remote operator console application or operations program 74. When a trigger message is received by the operations program, the operations program will automatically access the originating integrated display 30 in either covert or two way engagement mode. The intent of this functionality to allow the remote operator to address situations initiated at or near the display 30 (on site), for example emergency situations, as quickly and efficiently as possible.

In a content management mode the display 40 of the communications module 20 is configured to display (from the first computer and associated memory) specified content, or, alternately, is configured to remotely receive from the remote operations module 60 (operations computer 70) the specified content for display in the covert surveillance mode. For example, the remote operator 82 manages the specified content from the operations console 80 of the remote operations module 60. Management by the remote operator 82 includes upload marketing or advertising multimedia. The marketing and advertising content may be managed from both the remote operator console 80 using the operations program 74, and an optional web-based application designed to be used by a client.

For example, when in the content management mode, the remote operator has the following functions available: upload marketing/advertising multimedia to a single display or a group of displays; and schedule run times for various video and/or multimedia loops and segments; and to create a loop from several segments. That is, a loop is defined as a collection of segments. Segments are defined as individual pieces of multimedia content. A segment could be a single JPEG image or a complete MP4 movie (complete with sound). A loop, therefore, can be considered as containing individual segments. The management of loops includes scheduling the looping display. When a loop is scheduled to run, all of the segments within the loop are played from beginning to end. A plurality of loops can be staged and scheduled for a display.

In a further embodiment, the multi-media segments, loops and multimedia content may also be “streamed” to the integrated display. Streaming the content to the integrated display facilitates integration, marketing, and management of “syndicated” advertising.

Other modes or configuration options for a communications module or integrated display 30 may include a local live mode wherein in integrated display is configured to display video from a local camera, e.g., the camera 22 in the integrated display 30.

Also, a picture in picture mode may include the integrated display 30 configured to display a smaller window on top of a main window. The smaller window can be configured to display the local live view and other content. The exact layout of the windows can be configured from the remote operator console using the operations program 74.

Referring to FIGS. 1-3, communication between the various components of the system 10 are discussed below. Messaging between the communications module 20 or the integrated display 30 and the remote operations module 60, and thereby the remote console 80 and operations program 74, may be accomplished via TCP/IP sockets (Internet protocol suite of (transmission control protocol and internet protocol). Upon power-up, the integrated display attempts to open a TCP/IP connection to the operations program 74 of the operations computer 70. The IP Address of the operations computer 70 is stored in a configuration file on the integrated display. In another embodiment of the invention, the integrated display may initiate a connection to one or more centrally located remote servers 64.

More specifically, messages between the communications module and the remote operations module may include a Common Message Header. All messages being sent between the integrated display and the remote operations module may utilize the common message header. One layout for the common message header is as follows: MessageLength Integer 4 Bytes; and MessageID Integer 4 Bytes.

A messages from the operations computer 70 of the remote operations module to the integrated display 30 may include the following sequence:
Message ID: (Heartbeat Request)
Description: The Heartbeat Request message is sent to the integrated display when an amount of time, e.g., 20 seconds, have elapsed without receiving a message from the integrated display. The integrated display is expected to respond with a heartbeat response message. If the heartbeat response message is not received from the integrated display in a timely manner, the remote operations computer closes the current connection and waits for the integrated display to establish a new one.

Another message format may have an 8 byte common message header. A messages from the operations computer 70 of the remote operations module to the integrated display 30 may include the following sequence:
MessageID: (Heartbeat Response)
Description: The Heartbeat Response message is sent to the integrate display in response to a Heartbeat Request Message (100).

Another message format may have an 8 byte common message header. A messages from the operations computer 70 of the remote operations module to the integrated display 30 may include the following sequence:
MessageID: (Connect)
Description: The Connect Message is sent to the integrated display 30 when the operator wishes to monitor the audio and video from the integrated Display. In response, the integrated display 30 will begin to capture audio and video and set up a multimedia stream to that it can be accessed remotely. In addition, the integrated display will respond with a connection ready message which contains the URL that the operations computer must use to access the audio/video stream.

Another message format may have an 8 byte common message header. A messages from the operations computer 70 of the remote operations module to the integrated display 30 may include the following sequence:
MessageID: 250 (Disconnect)
Description: The Disconnect Message is sent to the Display when the operator wishes to stop monitoring live video and audio from the unit. This message allows the LivePoint Display to stop capturing audio and video and to “tear down” the video/audio stream.

Another message format may have an 8 byte common message header. A messages from the operations computer 70 of the remote operations module to the integrated display 30 may include the following sequence:
Message ID: 300 (Engage Message)
Description: The Engage Message is sent to the LivePoint Display when the operator wishes to open a two-way audio/video session with the LivePoint Display. The engage message contains the URL that the LivePoint Display must use to access the audio/video stream from the Remote Operator Console Application. Upon receiving the Engage Message, the LivePoint Display opens the audio/video stream from the Remote Operator Console Application and displays the contents of the stream in place of the marketing/advertising content.

Another message format may have an 8 byte common message header. A messages from the operations computer 70 of the remote operations module to the integrated display 30 may include the following sequence:
MediaStreamURL String (Null-Terminated)
MessageId: 350 (Disengage Message)
Description: The Disengage Message is sent to the LivePoint Display when the operator wishes to stop the two-way audio/video session. When this message is received, the LivePoint Display will close the connection to the audio/video stream provided by the Remote Operator Console Application and the unit will return to displaying marketing/advertising media.

Other message format which may have an 8 byte common message header, for messaging from the integrated display 30 to the operations computer 70 of the remote operations module, may include the following messages and descriptions:
Message ID: (Heartbeat Request)
Description: The Heartbeat Request message is sent to the Remote Operator Console Application when 20 seconds have elapse without receiving a message from the Remote Operator Console Application. The Remote Operator Console Application is expected to respond with a Heartbeat Response Message. If the Heartbeat Response Message is not received from the Remote Operator Console Application in a timely manner, the LivePoint Display closes the current connection and attempts to open a new connection to the Remote Operator Console Application.
MessageID: (Heartbeat Response)
Description: The Heartbeat Response message is sent to the Remote Operator Console Application in response to a Heartbeat Request Message.
MessageID: (Connection Ready)
Description: The Connection Ready message is sent from the LivePoint Display to the Remote Operator Console Application in response to receiving the Connection Message.
MessageID: 400 (I/O Trigger State Change)
Description: The LivePoint Display sends the Trigger message whenever the state of a connected trigger (I/O Port) changes.

The operations program 74 or software may also be referred to as a remote operator console application. The operations program 74 may be a Windows® based application that is designed to facilitate central operations for one or more integrated displays or communications modules. The majority of operations may be managed/dispatched by the software. The program 74 dispatches tasks to available operators. When a task is dispatched to an available operator, the operator has a pre-defined number of seconds to accept the task. If unaccepted, the task will be dispatched to an alternate operator or will be left on the queue for when an operator is available. A screen of the operations computer 70 may display the type of task, such as a trigger alert, and the account and location.

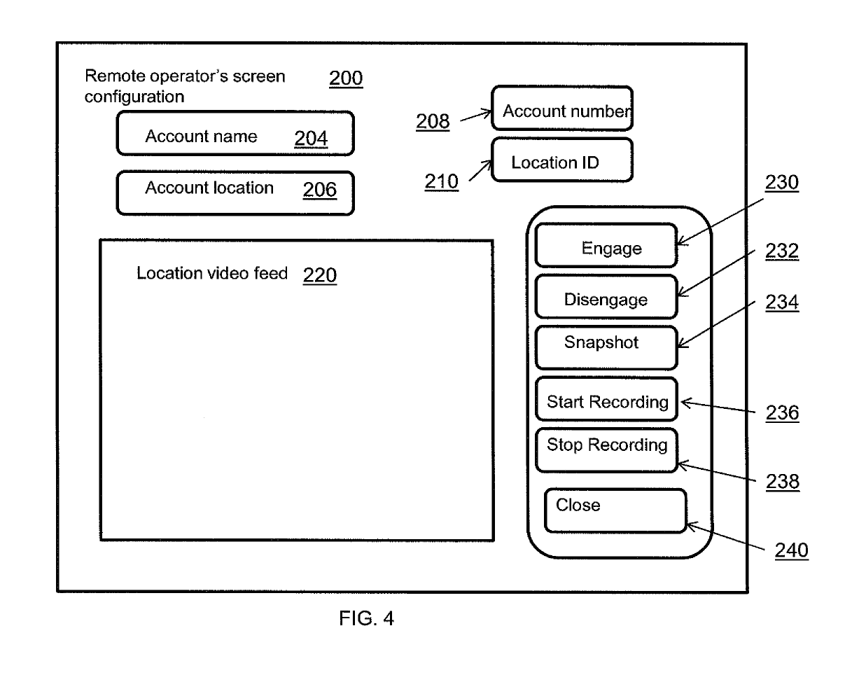

Further in the above example, once the task has been accepted by the operator, the operator is presented with the task detail, including the live audio and video from the integrated display. In one example, the operator views a screen configuration 200 as shown in FIG. 4. The screen 200 includes the following information: account name 204, account location 206, account number 208, location ID 210. The screen further includes a live location video feed 220. From the screen 200 on the operations computer 70, the operator has the following options/capabilities:
Engage 230—Opens a two-way video and audio session with the integrated display. This allows the operator to interact with the people on location and to make broadcast announcements.
Disengage 232—Stops a previously-started two-way video and audio session.
Snapshot 234—Captures a video snapshot (e.g., single JPEG image).
Start Recording 236—Starts the recording of audio and video.
Stop Recording 238—Stops the recording of audio and video.
Close 240—closes (or completes) the task including closing the connection to the integrated display.

In another alternative, the integrated display has a built-in web server that hosts an integrated web site to facilitate the configuration of the integrated display as well as the management of advertising and marketing media. In this embodiment, administrative personnel can access the integrated by site by entering an IP address into a web browsers. The web site is secure, thus the administrative personnel will need to enter a user name and password when prompted. The integrated display is supplied with a default administrator user name and password. Once successfully logged in, the administrative personnel will have the ability to perform the following functions via the web interface:
Make changes to unit configuration information and adjust basic operational parameters;
Add or delete previously-staged multimedia files;
Upload a new multimedia file (e.g., segment) and/or initiate streaming of video or multimedia content to the integrated display;
Add/Edit, or delete multimedia loops;
Schedule loops or streaming content to be played at certain times throughout a given day, or for example, certain days of the week;
Enable/disable certain unit features, such as a picture within a picture; and
Configure certain unit features to be enabled/disabled according to a pre-defined schedule.

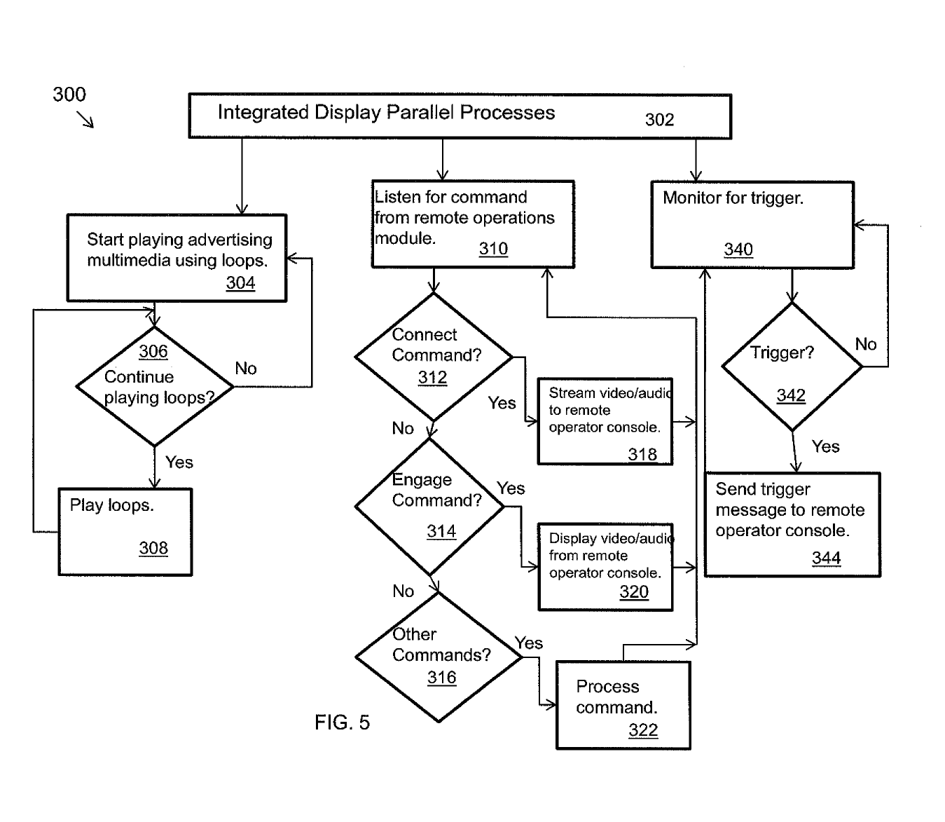

Referring to FIG. 5, a method 300 according to an embodiment of the invention of interaction between the integrated display 30 and the remote operations module 60 includes three processes in parallel 302. Step 304 includes playing A/V advertising content using multimedia segments, e.g., played in loops, or other streaming video or multimedia content. Step 306 includes inquiring whether to continue playing the streaming content or loops. If yes, the integrated display continues playing the current loop at step 306. If no, the flow chart goes back to step 304 to play a new loop.

In second parallel process, Step 310 includes listening for a command from the remote operations module 60. A received connect command is in step 312, an engage command in step 314, and other commands are in step 316. If a connect command is received in step 312, the process at step 318 configures the system to stream video/audio to the remote operator console to perform surveillance monitoring by the remote operator 82 while advertising content is being displayed at display 30. If an engage command is received in step 314, the process at step 320 displays video/audio from the remote operator console. If other commands are received, the flow chart goes to step 322 to process those commands.

Step 340 includes monitoring for a trigger. The trigger is initiated by a person at the area of surveillance (i.e., on site). Step 342 inquires whether the trigger has been activated. If the trigger is activated, the flow chart goes to step 344 to send the trigger message to the remote operator console 80 for responsive action. If the trigger has not been activated, the flow chart maintains step 340, monitoring for the trigger.

The remote operations module 60 has similar methodology for the remote operations module in response to the integrate display 30, including listening for and receiving a trigger signal. Also, the remote operation module 60 queues tasks initiated from the remote operator 82, and implements the task in order of receipt or by priority.

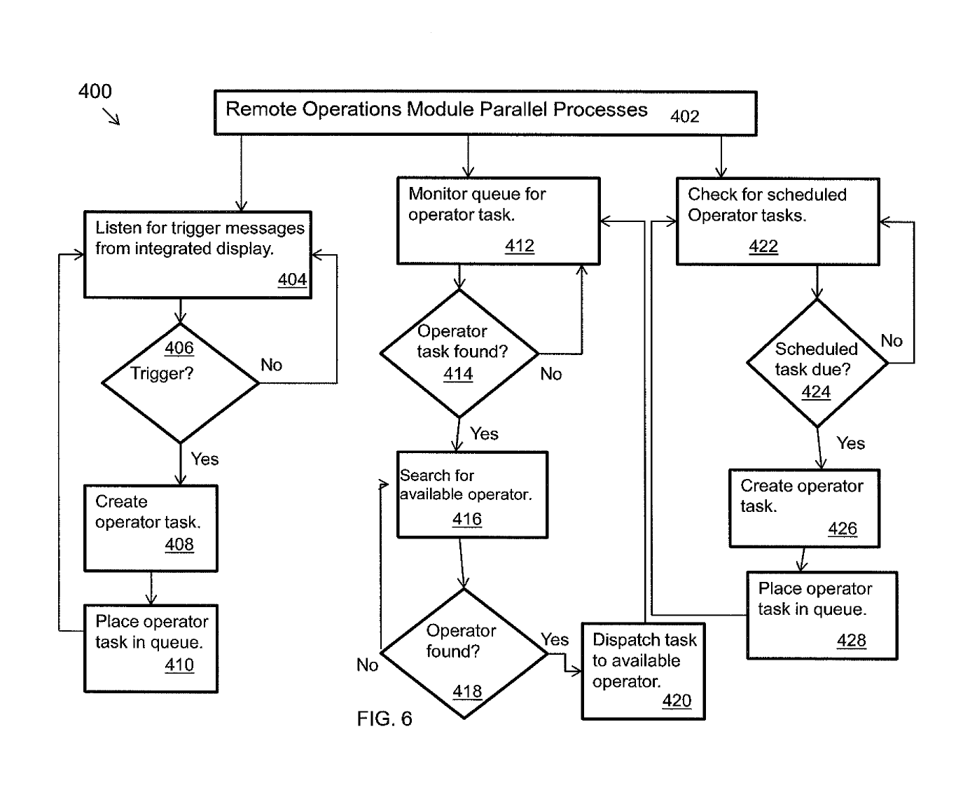

Referring to FIG. 6, in one embodiment of the invention, a method 400 includes interaction between the remote operations module 60 and the integrated display 30 and includes three processes in parallel 402. Step 404 includes listening for trigger messages from the integrated display. Step 406 includes inquiring whether a trigger signal has been received from the integrated display, e.g., from switch 34 (shown in FIGS. 1, 2 and 7). If yes, the method creates an operator task in step 408 and places the operator task in a queue in step 410. If no, the method returns to step 404 to listen for trigger messaged.

In a second parallel process, step 412 includes monitoring a queue for operator tasks, such as tasks 230-240, shown in FIG. 4. Step 414 includes inquiring whether an operator task is found. If yes, a search for an available operator is conducted in step 416. Inquiry is conducted as to if an operator is found in step 418. If no operator is found, the method goes back to step 416 to search for an operator. If an operator is found, the method dispatches the task to the available operator in step 420.

In a third parallel process, step 422 includes checking for scheduled operator tasks. Step 424 inquires whether a scheduled task is due. If a task is due, the method creates an operator task in step 426, and places the task in a queue for an operator in step 428. If a task is not due, the method returns to step 422 to check for scheduled operator tasks.

Referring to FIG. 8, an embodiment of a multi-screen display 600 of the remote operator's 82 computer 70 is shown, which is also referred to as the operator's console 80, has, in one embodiment, three screens, an application screen/dashboard 602, a work/task screen 604, and a video screen 606. The application screen 602 accommodates application functionality including scheduling, account contact lookups, generating reports, etc. In addition, this screen displays the operator's dashboard. The work screen 606 displays work/task items for the operator to interact with by “clicking” on an action 612 and performing associated tasks. The work screen 604 can also be used to investigate possible tasks or actions when no active task is present. The video screen 606 includes video from one or more cameras associated with displays at one or more sites, in on one or more areas at each site. The video screen may show one camera feed, or show multiple cameras each in one pane 614 of the video screen 606. If a task is active, the video will be related to the active task.

While the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

What is claimed is:

1. A system for communicating content to, and monitoring of, a specified area, comprising:
a communications module including communication devices, the communication devices including a display, a video camera, and a microphone, the communications module including a first computer;
a remote operations module including an operations computer, the remote operations module communicating with the communications module using the operations computer, the operations computer communicating control messages for receipt at the communications module for configuring the communication devices of the communications module and controlling operations of the communications module,
wherein, in a first operation mode, said display is configured to display specified content while simultaneously providing a remote operator of the remote operations module with real-time video from the video camera for surveillance monitoring.

2. The system of claim 1, including a second operation mode wherein said display of specified content includes display of content including a video or image of said remote operator of the remote operations module, said second operation mode being initiated from the remote operations module.

3. The system of claim 1, wherein the communications module further includes digital input and output ports, at least one I/O port connecting a trigger configured to initiate an alert mode of operation when activated, said alert mode including communicating from said communications module, responsive to a trigger activation, an alarm communicated as an alarm signal to the remote operations module for responsive action.

4. The system of claim 1, wherein the specified content of the display includes: information; advertisement information; one or more images; information including instructions, or streaming video content.

5. The system of claim 1, further comprising:
an operations program being embodied in a non-transitory computer readable medium of the operations computer and in communication with the first computer; and
a communications program being embodied in a non-transitory computer readable medium of the first computer and in communication with the operations computer.

6. The system of claim 1, comprising:
a plurality of communications modules each including a communications program being embodied in a respective non-transitory computer readable medium, each of the plurality of communications modules communicating with each of a plurality of respective computers.

7. The system of claim 4, wherein the first operation mode is a covert mode wherein the remote operations module is configured to receive audio and video communication from the communications module, and the communications module is configured to display the specified content.

8. The system of claim 3, wherein the second operation mode is a two way engagement mode wherein the remote operations module is configured to receive real-time audio and video communication from the communications module for real-time monitoring, and the communications module is configured to simultaneously display content including a video or image of the remote operator.

9. The system of claim 8, wherein said communications module and remote operations module are configured according to the second operation mode as responsive action to receiving said alarm signal.

10. The system of claim 1, further comprising:
a content management mode wherein the communications module is configured to receive uploaded or streamed multimedia content content, and the content management mode is initiated and controlled by the remote operation module, the content management mode includes the communications module being configured to upload or stream marketing or advertising multimedia content.

11. The system of claim 10, wherein the content management mode includes a loop mode which includes a plurality of segments of content which the communications module is configured to play in a continuous loop.

12. The system of claim 11, wherein at least one of the plurality of segments of content includes data for an image, or data for a movie.

13. A method for communicating content and monitoring a specified area, comprising:
communicating, from a remote operations module, control signals for receipt at an integrated display which includes a display device, video camera and a microphone, and a first computer;
configuring, at the integrated display, responsive to the control signals, the display device, video camera and a microphone of the integrated display in a first operation mode for covert surveillance of the specified area;
initiating, from the remote operations module, a display of specified content at said configured display device of said integrated display; and,
receiving, at an operations computer of the remote operations module, real-time signals from the configured video camera and microphone of the specified area for video and audio surveillance monitoring by a remote operator in said first operation mode while simultaneously displaying said specified content at the display of said communications module.

14. The method of claim 13, further including:
selectively initiating a plurality of operation modes using the remote operations module, the plurality of operation modes including:
initiating the first operation mode; and
initiating the display to display a video or image of a remote operator of the remote operations module in a two way engagement, in a second operation mode.

15. The method of claim 14, further comprising:
initiating an alarm by activating a trigger connected to said communications module, and, generating, at said communications module an alarm signal for communication to the remote operations module for responsive action thereat.

16. The method of claim 13, wherein said specified content comprises information; advertisement information; one or more pictures; information including instructions, or streaming video content.

17. The method of claim 15, further comprising:
receiving said alarm signal at the remote operations module and configuring the remote operations module to receive real-time audio and video communication from the communications module in said alarm mode;
wherein said communications module and remote operations module are configured according to the second operation mode as responsive action to receiving said alarm signal.

18. The method of claim 13, further comprising:
receiving the specified content at the communications module in a content management mode wherein the content management mode is initiated and controlled by the remote operation module; and
uploading or streaming marketing or advertising multimedia in the content management mode to the communications module for display.

19. A computer program product comprising a non-transient computer readable medium having recorded thereon a computer program, a computer system including a processor for executing the steps of the computer program for communicating content and monitoring a specified area, the program steps comprising:
communicating, from a remote operations module, control signals for receipt at an integrated display which includes a display device, video camera and a microphone, and a first computer;
configuring, at the integrated display, responsive to the control signals, the display device, video camera and a microphone of the integrated display in a first operation mode for covert surveillance of the specified area;
initiating, from the remote operations module, a display of specified content at said configured display device of said integrated display; and,
receiving, at an operations computer of the remote operations module, real-time signals from the configured video camera and microphone of the specified area for video and audio surveillance monitoring by a remote operator in said first operation mode while simultaneously displaying said specified content at the display of said communications module.

20. The computer program product of claim 19, further including:
providing selective initiation of a plurality of operation modes using the remote operations module, the plurality of operation modes including:
providing selective initiation of the first operation mode; and
providing selective initiation of a second operation mode which initiates the display to display a video or image of a remote operator of the remote operations module in a two way engagement.
